(19) United States
(12) Patent Application Publication
(10) Pub. No.: US 2013/0041686 A1
(43) Pub. Date: Feb. 14, 2013

(54) HEALTH CARE BROKERAGE SYSTEM AND METHOD OF USE

(71) Applicant: Noah S. Prywes, Bala Cynwyd, PA (US)

(72) Inventor: Noah S. Prywes, Bala Cynwyd, PA (US)

(21) Appl. No.: 13/207,034

(22) Filed: Aug. 10, 2011

(51) Int. Cl. G06Q 50/24; G06F 17/27

(52) U.S. Cl. 705/3; 704/9

(57) ABSTRACT

A health care brokerage service and method comprises a communication service for servicing users, patients and providers through the internet and/or via phone by speech, through user guides. The health care brokerage service also comprises a brokering service that users, patients and providers can utilize for finding each other and broker services of health-care events and a compliance service for enhancing compliance by patients with health-care events, through persistent reminders and through retaining and evaluating compliance history, wherein the system implementation incorporate users interfaces, storage of related data, and the execution of requested services.

### CROSS-REFERENCE TO RELATED APPLICATIONS

None.

### STATEMENT REGARDING FEDERALLY SPONSORED RESEARCH OR DEVELOPMENT

The present invention was not developed with the use of any Federal Funds, but was developed independently by the inventor.

### BACKGROUND OF THE INVENTION

### I.1 Benefits of the Health Care Brokerage

The system and methods of the present invention facilitate the frequent health related occurrences where patients, health providers and their associates require communicating reliably in the scheduling of medical events and issuing reminders. The main benefits are as follows:

1. The Health Care Brokerage serves as a personal health concierge. It is also a two-way nagging service for health care providers and patients. It searches addresses to reach the parties needed to complete the scheduling of medical events. It mediates the schedule to achieve an agreement between an initiator/requester and destination/responding parties and it follows with reminders. It frees the initiating party of contacting the other party in initiating an event. In summary, it serves as a broker, between initiators/requestors and destination/responder users of services. Brokerage of health care services is offered to patients to find health care providers, and to providers to find patients. Either party can be assisted by associates; providers by their staffs, who are engaged in scheduling events, and patients, by their family and friend.

2. The Health Care Brokerage System contributes to good health. It maintains a history of compliance with health events. Ninety percent of the public know that healthy habits are important, and that they need to do more than they are doing. It has been demonstrated that reminding patients to adhere to healthy habits results in reduced health costs and improved performance on the job.

3. The history of a patient's adherence to medical events is useful as a guide for improving health. Recent studies indicate that locating high non-compliance patterns can find clusters of situations of high costs of health care. Such patients could benefit from specialized assistance.

The Health Care Brokerage System is not envisioned to require referring to medical records or making medical decisions. Instead, it serves as an automated personal concierge of scheduling healthy habits, available 24/7 through static and mobile devices, by speech or text. It provides monthly, weekly and daily calendars of total patient's medical events and their reminders. It does not require additional medical input beyond what is needed for scheduling and reminding. The identifications of patients in the Health Brokerage System can be used, for example, by physicians to locate a respective patient's medical record in the physician's own system and complete medical analysis and diagnosis leading to prescription. Thus the Health Care Brokerage system can operate independently of medical care on line systems. It can however interact with other systems through lineage connection (described later)

The demographic distribution of users spans widely. Younger users are generally versed in Internet technology and are capable of using more complex text communications of the Health Cate Brokerage system. Users may use the easy-to-use services offered at home and on-the-go, by Internet, or alternately use of natural language speech by telephone. The service is offered interchangeably, through Internet website static or mobile devices and through natural speech by telephone. The telephone services are oriented to handicapped users who have difficulty in following textual instructions and finding where to click or enter information on an Internet page. The telephone is also more proactive and persuasive than Internet website or email. The services by telephone emulate carefully the service by respective website pages. And, a user can switch from one to the other. They utilize built-in directories and speech recognition grammar.

### I.2. Economic Considerations of the Health Brokerage System

The savings and improved effectiveness of health related services due to use of the system would more than cover the cost of the service.

The service is planned to be used free by the public at large. This is expected to accelerate usage of the system.

The present invention will also be offered for sponsorship by companies that benefit from the improved adherence to healthy habits by their customers, employees or insurance members. The benefits are in the form of reduced cost of health care, improved work performance and increased revenues. The beneficiaries, employers and health plan insurers, would realize respective savings in health care costs. Other beneficiaries are providers of products used in healthy habits such as pharmacy and pharmaceutical companies. It can be used also to connect with patients requiring clinics that oversee medical condition protocols. Cost of rewards for adherence would be covered by the respective sponsors.

It is reported that there are currently a billion reminders of medical events by phone annually in the U.S. from providers to patients. The Health Care Brokerage system could deliver them more proactively, with greater reachability, and at lower cost. Providers may benefit from proactive persistent scheduling, confirming and reminding of appointments that would improve attendance of patients for appointments.

Sponsors can advertise the service to their respective employees, plan members, customers, and the like. Sponsored users will be recognized automatically. Registration to protect privacy by password will also be easy. It can use information from the sponsor for easier enrollment in the service. It can recognize user's voice for those using services by speech.

### SUMMARY

The system and method of the present invention comprises a system of networks, processors, and storage for facilitating communications between providers and patients for initiating, scheduling, and complying with health care events.

The Health Care Brokerage focus is on health care events. Such event services are offered in the following applications:

For scheduling, reminding or confirming medical appointments, testing and procedures;

For prescribing medications and reminding compliance;

For soliciting patients to perform self measurements and report the results;

For scheduling, reminding adherence or confirming weight control by patients;

For scheduling, reminding adherence or confirming exercising by patients; and

For allowing overseeing of health care activity of patients by associates, such as family or friends of patients or professionals

The system and method of the present invention has several unique features:

1. The participants in an above application are a patient and a medical service provider, as well as associates, who assist respective parties in scheduling and complying with events. The system communicates with them in regard to an event of common interest. The Health Care Brokerage system serves as a broker and it mediates between the patient and provider to reach a commonly accepted schedule and due reminders for the duration of the event. The system facilitates patients in finding providers and providers in finding patients. It then negotiates new or modified schedule for the health care events.

2. The system communicates with providers and patients using multiple modes of Internet website pages, email, SMS, natural speech by phone, or the like. The service by speech makes communication easier especially for the older or sick patients who are not as capable of reading text instructions and entering data in designated places on website pages. The service by speech is also more proactive in reaching patients and providers. It is easier to find phone numbers of providers and patients through readily available telephone directories. The services by speech must be consistent with respective website pages. Their development, maintenance and updating are a laborious task. The Health Care Brokerage system utilizes a tool called Web-Planner to produce natural language services by speech via phone and maintain consistency with services by Internet.

3. The system includes an easy-to-use service that is consistently simple to use by Internet or phone.

4. In order to assure that the communications in regard of events reach their intended destinations, the system may repeat the contacting of parties to scheduling an event by using alternate modes of Internet website, email and speech by phone, until contact is confirmed, while advising the originator of a request of the progress in reaching the other party. Further, mediating in scheduling an event requires a number of back and forth provider and patient communications.

5. The system evaluates the compliance of patients with prescribed instructions in events. This data is useful to finding poorly-complying patients who may require specialized professional care to improve patient health and reduce health care costs.

6. To make the system easy to access and use it widely, it avoids depending on medical records or medical condition information. Such information may be found in other on-line systems. However the system includes access to provider supplied on-line systems and publicly available free directories on providers, pharmacies, and the like. A linkage mechanism is provided to make such communication easier. However the Health Care Brokerage system can also be used independently of other on-line systems.

In accordance with the present invention, a health care brokerage service and method which addresses the objects described above is shown and described.

The health care brokerage service comprises a communication service for servicing users, patients and providers through the internet and/or via phone by speech, through user guides. The health care brokerage service also comprises a brokering service that users, patients and providers can utilize for finding each other and broker services of health-care events and a compliance service for enhancing compliance by patients with health-care events, through persistent reminders and through retaining and evaluating compliance history, wherein the system implementation incorporate users interfaces, storage of related data, and the execution of requested services.

In one form of the invention the health care brokerage includes automatically mediating the scheduling of an event and reaching an agreement between an initiating party and a destination party and proactively and persistently communicating between the initiator party and the destination party for agreeing on the scheduling of the event based on the event specified by the initiator party. The health care brokerage searches directories to locate membership, email or telephone addresses for the selected destination parties and communicates proactively, through Internet and/or telephone calls, as necessary, with the destination party with a request to agree on a schedule of the event, the service reports to the initiator party the progress in contacting the destination party. If contacted, the brokering service reports to the initiator party the response of the destination party on agreement on the schedule, if agreement is reached, the brokering service updates the event for both the initiating and destination parties and establishes due reminders. If no contact is made with the destination party, after repeated trials, or if there is no agreement on the event, the brokering service solicits from the initiator other schedule or other destination parties and repeats the above process to schedule the initiator requested event.

In another form the invention the health care brokerage service includes creating Interactive Voice Response (IVR) programs, semi-automatically, that emulate respective website pages, for users to employ natural language in communicating with the system same as with respective website pages that offer the same respective service. the health care brokerage service further includes a tool which uses as inputs the source website page code and a high level call flow of the emulation of the website page service by speech, the call flow includes commands to generate natural language prompts, to access, store, and update storage via the website code; and for using natural language grammar systems and directories to understand the user's utterance.

The compliance service may further comprise managing the compliance with health care events analyzing the healthcare event compliance history and creating an index of compliance of patients with the health care events, and finding non-compliant patients that need special services to improve their compliance and to reduce health care costs.

The health care brokerage may further comprise a service for having a trusted associate dub free speech in his/her own voice in system prompts to users, thereby increasing the familiarity and friendliness of the communication to non-complaint patients to improve compliance and reducing cost.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a schematic view of a Health Brokerage System and method;

FIG. 2 is a schematic view of overview of the Health Brokerage system architecture and flow of information of the Health Brokerage System of FIG. 1;

FIG. 3 is a schematic view of the layout of a modular page of the Health Brokerage System of FIG. 1;

FIG. 4 is a schematic view of the Home & Registration Page of the Health Brokerage System of FIG. 2;

FIG. 5 is a schematic view of the At-A-Glance Page of the Health Brokerage System of FIG. 2;

FIG. 6 is a schematic view of the New Appointment page of the Health Brokerage System of FIG. 2;

FIG. 7 is a schematic view of the provider's new medication prescription page of the Healthcare Brokerage System of FIG. 2.

FIG. 8 is a schematic view of the Calendar page, giving an overview of Events and Reminders of the Healthcare Brokerage System of FIG. 2

FIG. 9 is a schematic view of the major entity relationship of the relational database for a Sponsor/Customer of the Health Brokerage System of FIG. 1;

FIG. 10 is a schematic view of the major entity relationship of the relational database for a Associate/Patient of the Health Brokerage System of FIG. 1;

FIG. 11 is a schematic view of the major entity relationship of the relational database for a Appointment/Patient/Provider of the Health Brokerage System of FIG. 1;

FIG. 12 is a schematic view of the major entity relationship of the relational database for a Medicine/Patient of the Health Brokerage System of FIG. 1;

FIG. 13 is a schematic view of the Overview of the Web-Planner tool Process of Creating the IVR program of the Healthcare Brokerage System of FIG. 1; and

FIG. 14 is a schematic view of execution of IVR program, utilizing executives IVR-Sims and Web-Sims of the Health Brokerage System of FIG. 1.

### DESCRIPTION OF INVENTION

### Definitions

The Following are definitions of the key entities referred to in the following application:

User: A member of the public, such as a patient, or health provider or an associate as defined below.

Initiator: A user requesting or offering a new event.

Destination: A user responding to Initiator for a new event.

Registering: For verifying privacy as well as sponsorships of patient.

Login: Controlling user access and privacy through password for Internet, and through voice verification for telephone.

Event: Creating and updating of medical appointment, filling medicines, exercising, taking medical measurements, and the like. Events are medical instances that are subjects of reminders.

Alerts: Alerting associates of noncompliance with a critical event. Alerting provider of critical event.

Protocol: Treatment of medical conditions.

Reminder: Internet and telephone messages concerning respective events that urge compliance and sometimes require confirmation responses.

History: Information on adherence to events.

Facilitating Creation of Events: Searching directories of medical providers and pharmacies needed to create or modify events.

Administering user account: Initiating and updating registration (at initiation and later). Sharing the user account with authorized associates who are supportive/ encourage of adherence.

Rewards: Users may receive awards from sponsors for adherence to events.

Review: Examining long and short term calendar of reminders and respective events and evaluation of adherence.

Associate: A family, counselor, trainer, nurse, doctor, and the like that has access to account to setup reminder schedule and review adherence.

Members: Spouse and other dependents, such as children, sharing group membership.

Other Facilitation: A user may subscribe to other medical services which are made easy to access and transfer information.

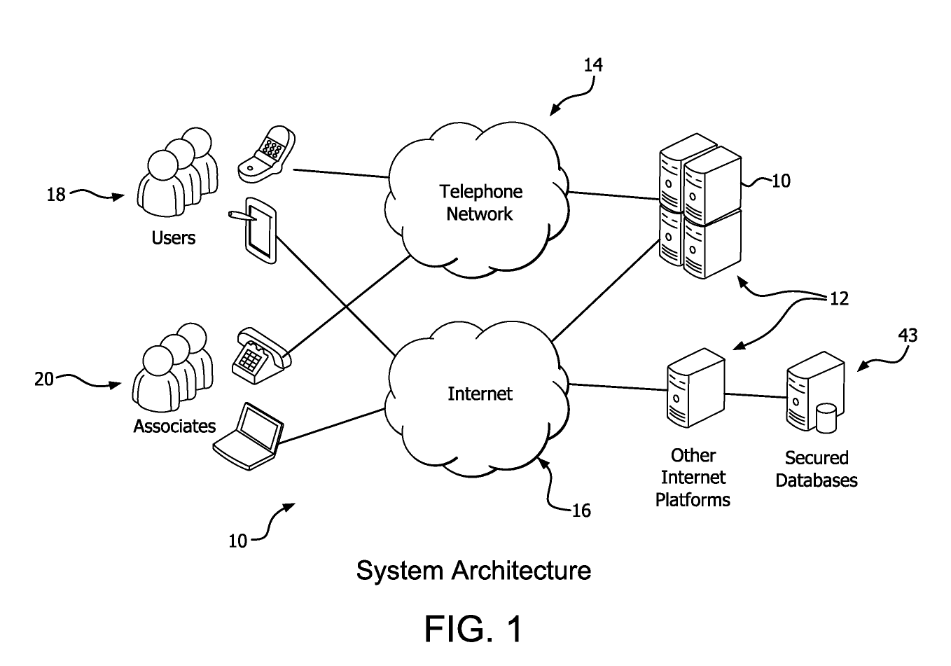

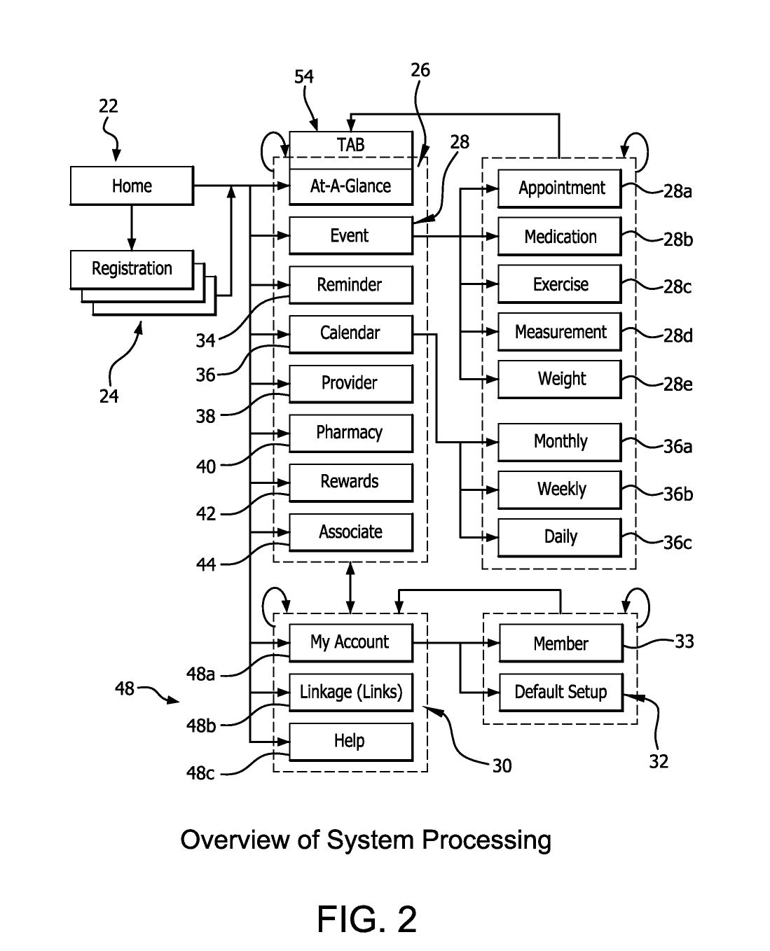

### IV.2. Overview of the Operation of the System (FIGS. 1 and 2)

### IV.2.A. High Level System Architecture (FIG. 1)

FIG. 1 shows a presently preferred embodiment of a Health Care Brokerage System and method 10. Referring now to FIG. 1, the System shows the processors 12, telephone 14 and Internet 16 networks databases 12 and 13, for performing the present invention.

The Health Care Brokerage System includes users 18, which include patients, health care providers, and the associates 20 who assist the respective patients or providers. A patient or a provider 18 would typically identify or refer to events of health care needs or offerings, as described in greater detail below. The Health Care Brokerage System communicates with a patient, a user 18, in regards to an ongoing event. An event is specific to an above listed application area and will be described in greater detail below. An associate 20 assists the patient 18 in securing and complying with events. An associate assists a provider in scheduling an event. The users 18 communicate with the system through Internet, telephone or wireless networks.

The system provides users 18 with access to information on events and reminders and on compliance with respective reminders. The system displays website pages of events and reminders (these pages and their operations are illustrated below). The system can offer similar services by speech by phone. Reminders may be further backed-up via email or phone. An event display includes information on its agreed schedule, reminders, and confirmations and on compliance with the reminders of the event. It also displays a calendar of health care event schedules and reminders that summarizes the current health care status of a user 18.

Most important, the Health Care Brokerage System mediates proactively communication between an initiator/requestor user 18, and destination/responder user 18, in determining of the schedule of a health care event. This is followed by the system generating timely reminders. The brokering of an event is accomplished through back and forth system communications with initiator user 18 and destination user 18. It advises each side of the current status and needed inputs to agree on schedule and reminders of an event. If there is no response from the destination user, the system repeats the communication. It utilizes website pages, email and telephone calls to reach the destination party. Initiator users 18 may search data directories to locate respective addresses and descriptions of destination users 18. The user 18 may also search for pharmacies.

The services by Internet 16 use web pages for informing the users 18 and capturing information from them. The service by telephone 14 use respective call flow specifications, implemented as Interactive Voice Response (IVR) programs, as described in greater detail below. There is a similarity between the Internet website pages and the respective call flows and their IVR programs. Thus, the two modes of Internet and speech are always consistent. As noted further below, a tool called Web-Planner is used to generate and update the IVR programs that emulate (and use) the functionality of respective website pages. In fact, the call-flow and IVR program utilizes the website functionality. The tool also uses directories and grammar to recognize utterances of users.

### IV.2.B. System Process (FIG. 2)

FIG. 2 showed an overview of the Health Care Brokerage System processing. FIG. 2 shows the operation of the system through boxes, each with name of respective function. Each box is implemented by respective user guide of website screen pages. The pages provide or solicit user information. The arrows in the diagram show flow among the pages. The flow may be controlled by a user through use of TABs or automatically by the system services as described below.

Entry to the system is through the Home 22 page shown at top left of FIG. 2. A new user may elect to go through Registration 24 to be issued a password or voice verification (unregistered users will only be offered limited services).

The system supports multiple choices of sequences of use. A less versed user is offered an easy-to-use path of activity. It is denoted by broken line frame around respective boxes in FIG. 2. The easy-to-use path is especially important on-the-go when using a mobile phone where short calls are preferred. A user more familiar with the service is allowed to take short-cuts directly into the various function boxes through use of TABs 54. The easy-to-use user can optionally use speech recognition to obtain similar results.

Referring to FIG. 2, from Home 22, or through Dial, after logon, the user enters into the At-A-Glance page 26. The At-A-Glance page 26 lists the highest priority pending reminders (described below). The user may proceed from there to click on the selected reminder to denote that the respective reminder has been complied with, deleted or postponed, or click on a selected reminder to examine the respective event page; Complying with an event updates the respective Event 28 and Reminder 34 pages of the initiator and destination users (described below).

The user may transfer to other services such as creating new, or modifying, events. The more familiar user may use directly any TAB 54.

Prior to initiating request for a new health care event, the user may use the system to search for the complementing destination party. The initiator of an event may search a directory through the Provider 38 and Pharmacy 40 pages to locate a complementing party. For example, a patient requiring a new appointment with a provider may search the directory for providers. A provider who wants to send a prescription to a patient will need to search for the patient ID.

The initiator and destination users are parties in creating a new event type. The initiator makes the request for a new event using the Event page the system, then communicates the need to the specified destination party to find agreement of service and schedule. The initiator must be a user of the system. The communication is via website pages if the destination is also a user of the Health Care Brokerage System. The request of an event is also reinforced by email or telephone to the destination party. If the destination party is not a Health Care Brokerage System user then the communication to the destination party is only by email and/or by phone, and requesting answer. If there is no response, the system repeats the request. The system also advises the initiating party of progress in contacting to the other party.

If both patient and provider are users of the Health Brokerage System (FIG. 1, 10), then the system communicates via New and Modified Event pages (see below) in their respective accounts, through respective Reminders pages 34 and At-A-Glance pages 26

As noted, the initiator/requestor of an event must be user of the Health Care Brokerage System, but the destination/may not be a user. Then the system communicates with the destination party via email/or phone. Such communication attempts may be repeated if there is no response. The system seeks confirmation for the request of an event via email or phone. The initiator/requestor is notified of securing a contact with such a destination and the response by At-A-Glance 26, Reminder 34 and Event 28 pages.

Once a selection of a destination is made by an initiator, the system generates a provisional new event page. If the destination is a user of the system, the system creates also a new event page for the destination user for the respective event, requesting scheduling the event (further described above). This is followed by an email or/and phone call to the selected provider, requesting for schedule confirmation or a schedule alternative. Once agreement by provider and patient is reached, on the schedule, the system will generate respective reminders following the instructions for timing and rate in the default page 32.

The destination may respond with agreement or modification of the event. Then the initiator may accept the schedule or request a new schedule or another destination

There are separate versions for event pages for patients and for providers. There are also selectable versions for event types, for example, for appointments, medications, self-measurements, diet and exercise 28a to e. The page for a patient requesting appointment 28a, and for provider producing a prescription 28b is 34 described below in detail and it also illustrates the other event pages. The other versions, Exercise event 28c, Measurement event 28d, and weight event 28e, are similar to the patient appointment page only customized for respective types of events.

The reminders are updated automatically by the system in accordance with the instructions in the default page. The default page allows the user to set default rules for the reminders' repetition rate, time and frequency set up using the Default page 32.

The Reminder and Compliance page 34 provides the user with a list of history of reminders and their compliance. It also can be used by the user to recall the respective event of a reminder, by clicking on it.

The reminders and compliance entries in this page are created automatically. First, whenever an event is created (after scheduling agreement is reached), the system then follows by generating a first reminder of the event, according to times, rates and frequency specified in the default page. Additional reminders are generated for subsequent activities of the event in due time.

A patient user can click on a reminder in At-A-Glance page or in the Reminder page to denote satisfying (completely or partially) compliance with the respective reminder. The system will then update the reminder in these pages.

Finally, a user may request in the Reminder page to get statistics of compliance and a Compliance Index, such as percentage of satisfying reminders, to be computed.

Sending of reminders by the system, in addition to using the website pages, can also be backed-up by email, phone and SMS, as specified in the Default page (described below).

As shown in FIG. 2, a user may view a calendar display 36, of reminders for month 36a, week 36b or day 36c.

The Pages for Providers 38 and Pharmacy 40 include names, locations, phone and emails of providers and pharmacies used to date, for easy reference

The Rewards page 42 is for managing customer rewards offered by sponsors.

The Associate page 44 is to give permission to allow a friend, family or provider to act in lieu of a user.

Finally there are auxiliary pages for examining a user's Account 48a, for searching by Linkage 48b and for obtaining Help 48c.

The operation of the system (FIG. 1, 10) is further described below through illustrative pages

### IV.3. Illustration of System Operation Through Examples of Screen Pages

This section provides additional details by presenting the operation of illustrative pages.

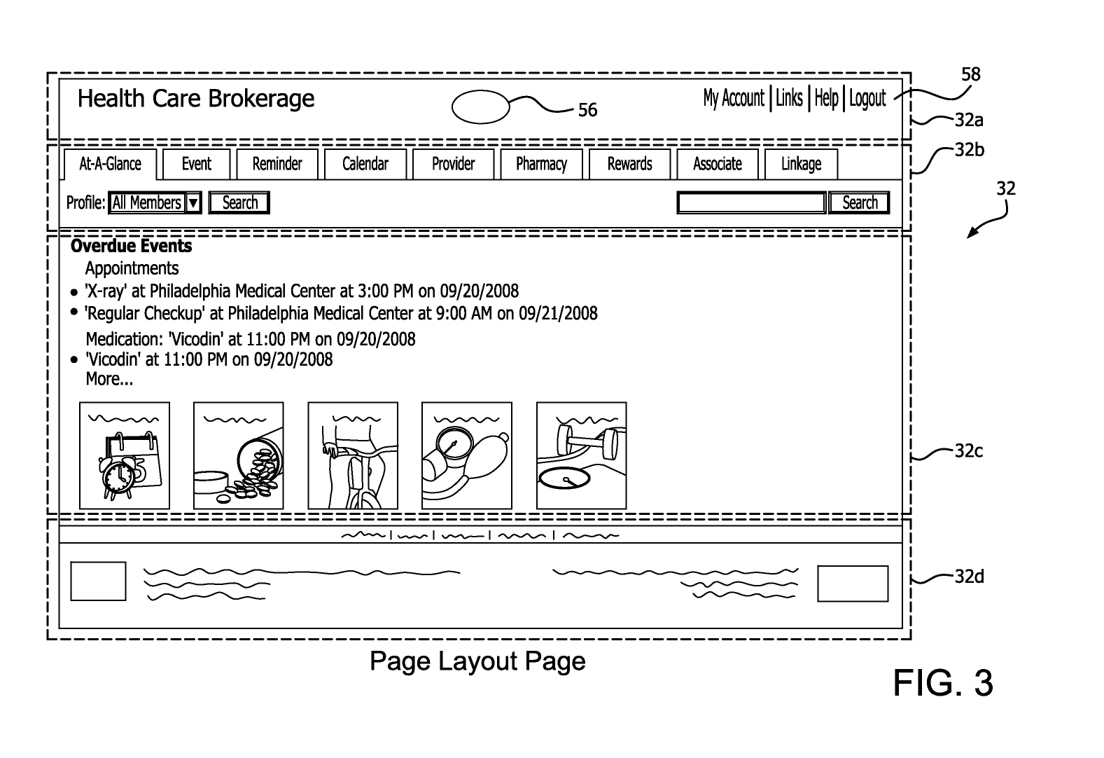

### IV.3.A General Page Layout (FIG. 3)

The general page layout for each page follows a template format as shown in FIG. 3. All pages have a similar layout. They are divided into four areas: the Top Area 32a, the Tab Area 32b, the Body Area 32c, and the Bottom Area 32d. The design of each page of the system follows the modular scheme to facilitate revisions and modifications and to achieve a uniformed design.

Referring now to FIG. 3, the Top area 32a has a sponsor logo in its center 56. On the right side 58 of the top area 32a, there are hyperlinks or selection buttons for the My Account page 48a, the Links page 48b, the Help page 48c (referring to FIG. 2), and for logging out of the system (not shown). It should be understood that other links or pages may also be includes and fall within the scope of the present invention.

The Tab Area 32b includes nine tabs or hyperlinks, including tabs for the At-A-Glance page 26, the various Event pages 28a-28e, the Reminder page 34, the Calendar page 36, the Provider page 38, the Pharmacy page 40, the Rewards page 42, the Linkage page 48b, and the Associate page 44 (referring to FIG. 2).

The Body Area 32c (see FIG. 3) contains the specialized contents of each page, as described below.

The Bottom Area [32d] contains has links to Privacy, Legal statement, About Us, and Contact Us pages [(not shown).]

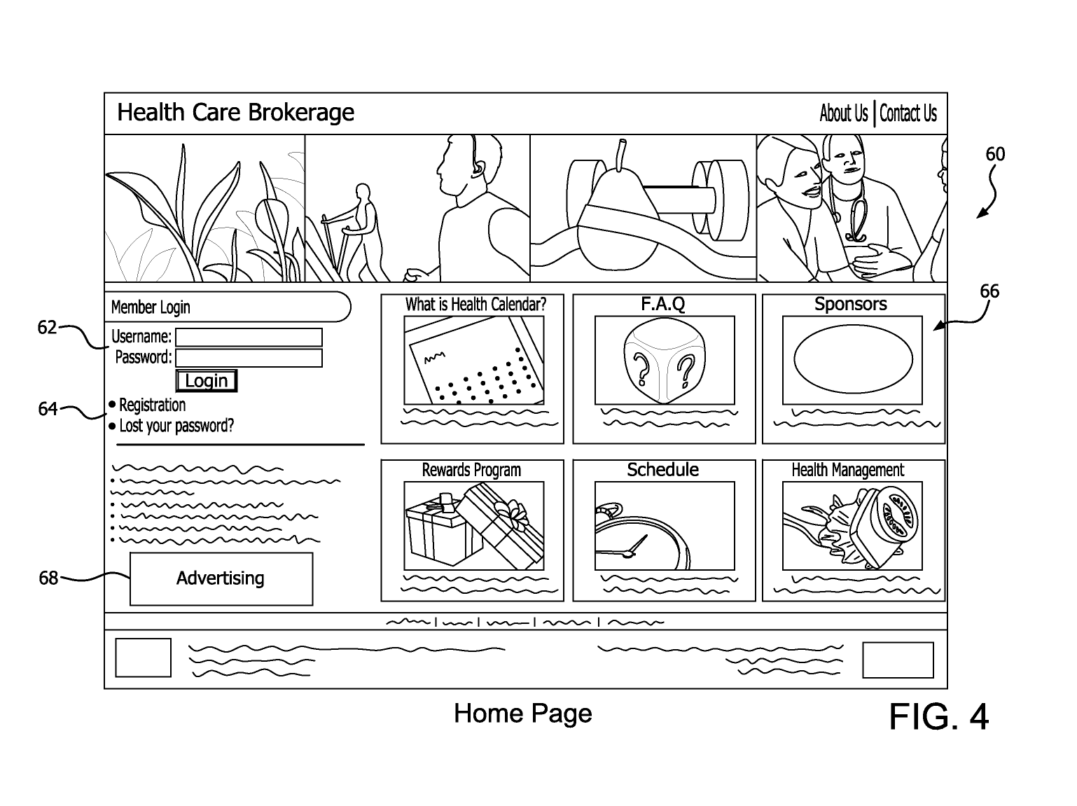

### IV.3.B. Home Page (FIG. 4)

As shown in FIG. 4, the Home page 60 comprises the three parts: Login 62, Registration 64, and General Information 66 about the Health Care Brokerage System. The Home page 60 may also contain advertising and links 68.

A user creates a new account by registering through the Home page 60. The general information area 66 provides details about the Health Care Brokerage System, a frequently asked questions section, and information about the sponsors.

While registering (click on 64), a user fills in personal information such as birthday, address, and phone numbers in the registration page (not shown). Users may be given a code by their sponsor, and then the personal information would be filled with data obtained from their sponsor. The user creates a password for login at this moment. Then, the user can add additional information and setup default values such as dependents information, insurance information, and default values on the default page (see FIG. 2, 32) for reminders. Users can skip this step and process it later, but then their event data will not be retained. During the registration process, users are asked to read and accept Terms and Conditions, and Privacy statement.

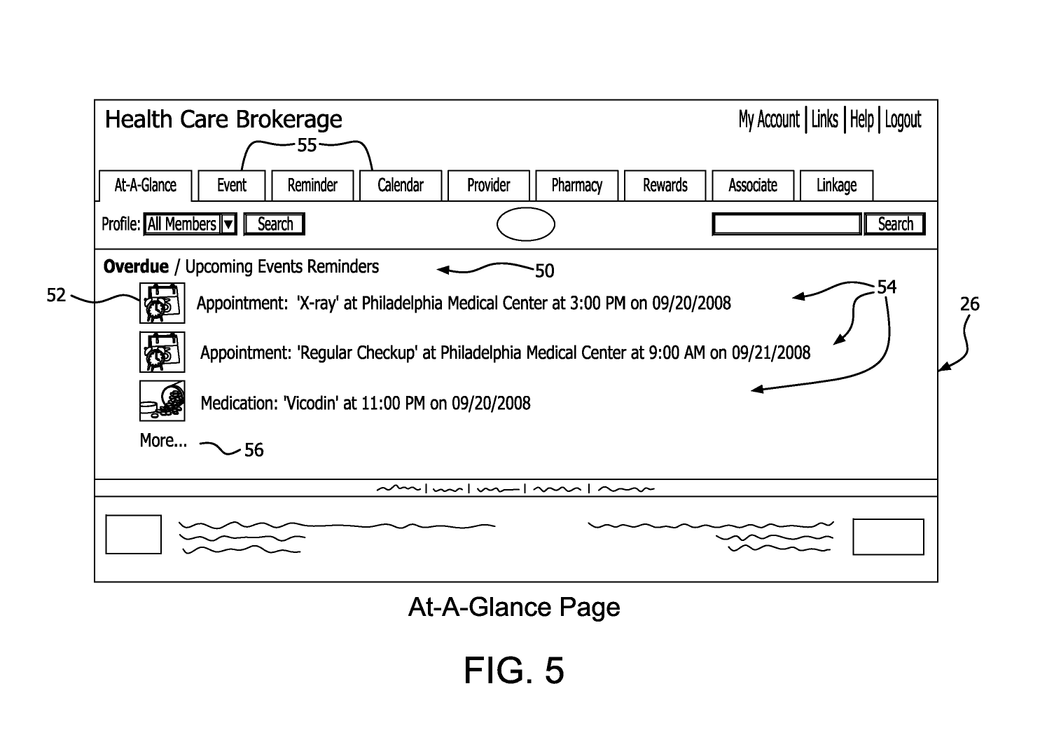

Based on login the system identifies whether the user is a patient or a provider and will display respective versions of pages. The system displays immediately the At-A-Glance page (FIG. 5 26 described below) after completing login.

### IV.3.C. At-a-Glance Page (FIG. 5)

The At-A-Glance 26 page is shown in FIG. 5. It is what users see immediately after the login. The purpose of the At-A-Glance page is to first alert users of pending reminders. The At-A-Glance page lists the most important pending reminders. Several examples are shown in FIG. 5 for appointment and medication 52.

Preferably, up to three reminders are shown at first, as shown 54. In this way, Users are guided to respond to high-priority overdue reminders first. Users can confirm these reminders as complied-with, overdue or pending, for respective events, at this moment, those up-to-three events 52 are the most important or urgent overdue events sorted by priority order. If there are more than three overdue events, users can see the rest of the list by clicking the ‘more’ link 56.

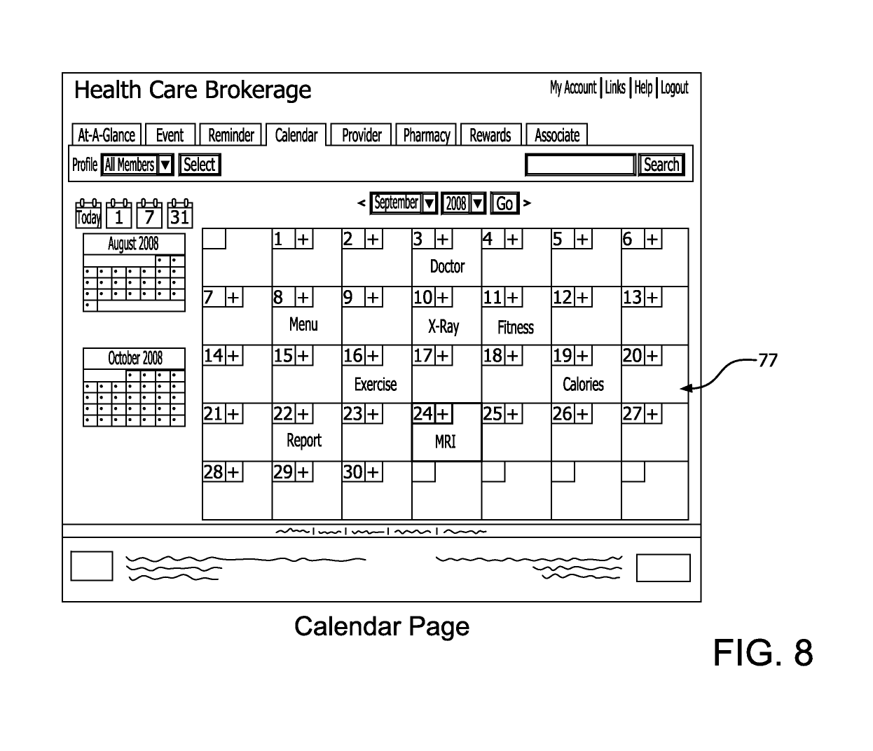

A user may need more information for responding to a reminder. A click on the reminder 54 on the At-A-Glance page 26 displays the respective event page and the user may respond from there. The user can get a new event page (see FIG. 2, 28) by clicking on the Event tab 55. Then a user will be able to select one of the five respective event types. Thus a user can reach all the events (see 28a-28e in FIG. 2) and reminders (FIG. 2, 34) from the At-A-Glance page (FIG. 2, 26). As will be shown, a user can also reach an event page 28 from a Calendar page (this is further shown in FIG. 8), a view with which most web-calendar users are familiar. The Health Care Brokerage System supports monthly (default), weekly and daily calendars. Users can click on an entry in the Calendar to display the respective event page (FIG. 2, 36).

In addition, there is a page with a list of all patient events for a provider, or all provider events for a patient. It includes the last date of reminder, the provider and patient names, email, telephone number and location. A user thus has a number of ways to get a quick view of an event detail from.

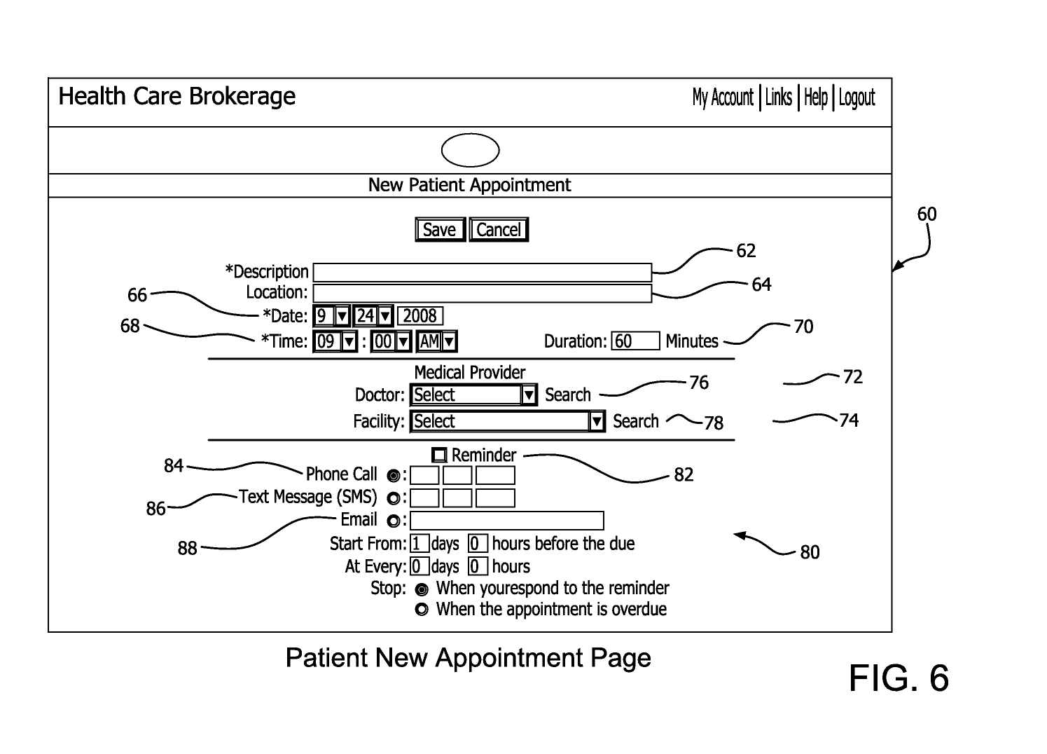

### IV.3.D. Patient New or Modified Appointment Event Page (FIG. 6)

Referring to FIG. 6, the event modification and addition function is now described. As a preliminary matter, it should be understood that the initiation and modification of events requires patient and provider agreement. For example, a patient requiring an appointment typically needs to select a provider. A provider search page can then be used to search for a medical provider or a patient may refer to a provider used in the past. The search may be by specialization, location or by name. Once selected, it could be added to the patient's search page, for later quick reference. On the right side of the provider search page (FIG. 2, 38) a table of providers which the user has added on to his/her account is displayed.

A pharmacy search page (FIG. 2, 40) is also being provided and is similar to the provider search page. Users can find pharmacies by name and/or location. Once a user finds a pharmacy, he/she can add it to the pharmacy list so that it can be easily re-used. Conversely, a provider has to input some identification, such as phone number, name, and the like, of the patient to initiate an event. The patient is then advised accordingly. A similar process is followed in respective versions of pages for provider offering an appointment and for prescribing medicine, soliciting self tests, dieting and exercising.

The process is further described below for a page version customized for patient/appointment. A similar process applies to versions customized to respective events of medication, tests, dieting and exercising.

A new appointment event creation page is shown in FIG. 6 to illustrate its operation. Referring now to FIG. 6, a new patient appointment creation page 60 is shown for creating and editing new patient appointments (Also FIG. 2, 28). The page includes a description entry of free text box 62 for entering in a brief description of the appointment. (note that system includes speech recognition directories to recognize patient utterance when using speech via phone) A location data entry box 64 is also provided for entering in the location of the appointment. The location of the appointment is an optional informational entry.

The new patient appointment creation page (FIG. 6) also includes a date entry area 66 and a time entry area 68 for entering in the start date and time of the appointment respectively. Also provided is a duration entry box 70 for entering the duration of the appointment. The duration of the appointment is also an optional informational entry.

The new patient appointment creation page also includes a section for selecting a provider 72 and the provider's facility 74. A doctor/provider 72 and doctor/facility 74 is selected from a public directory of doctors/providers which has been entered by the patient on a doctor/provider entry page. If the doctor/provider and/or location for a particular appointment are not in the directory then the r search hyperlink 76 and facility search linkage 78 are provided to facilitate finding the doctor and/or the facility via the Internet. When a user defines or modifies an event page, the system searches for the complementing party to complete/confirm the scheduling. The initiator of an event may search a directory to locate a complementing party. For example, a patient requiring a new appointment with a provider may search the directory for providers. Once a selection is made, the system generates a website new provisional event page for the patient, and a new page for the provider, if the latter is a user, followed by an email or/and phone call to the selected provider, requesting for schedule confirmation or a schedule alternative, as discussed below. Follow up reminders can also be made by SMS. In this way the patient can set a preferred schedule for an appointment or the patient may leave it up to the provider to suggest time for the appointment.

The new patient appointment creation page 60 also includes an optional reminder section 80 for setting up a reminder associated with the patient appointment. A schedule for reminders can be generated automatically based on instructions in the Default page. (FIG. 2, 32) If the patient wishes to set-up a special reminder schedule for the appointment, the patient can check the reminder selection check box 82. When a reminder option has been selected, then the patient chooses at least one contact method, such as contact via a telephone call 84, via an SMS message 86, via email 88, and the like. If the telephone call contact method 84 is selected, the patient enters the telephone contact number in entry box 88. If the SMS message contact method is selected, the patient enters a cellphone contact number in the entry box. If the email contact method is selected, the patient enters an email address in entry box.

The patient completes the Description (free text), Date, and Time for the event. Then the patient selects the provider. Optional information includes the Location and Duration of appointment. The patient can set a preferred schedule for the appointment and/or leave it up to the provider to suggest time for appointment. The Health Brokerage System attempts to contacts the provider through a website event page in the provider's account (if provider is user), and/or by email, or a phone call. The email or phone call is repeated if there is no response and the patient is notified. Once a schedule is agreed, the reminders are automatic (according to defaults) and continue until an event is done or overdue.

It should be understood that a new appointment may be initiated by a provider for a patient. Then the provider could enter the new appointment event in own appointment page, and the system will create a new appointment page in the respective patient's account.

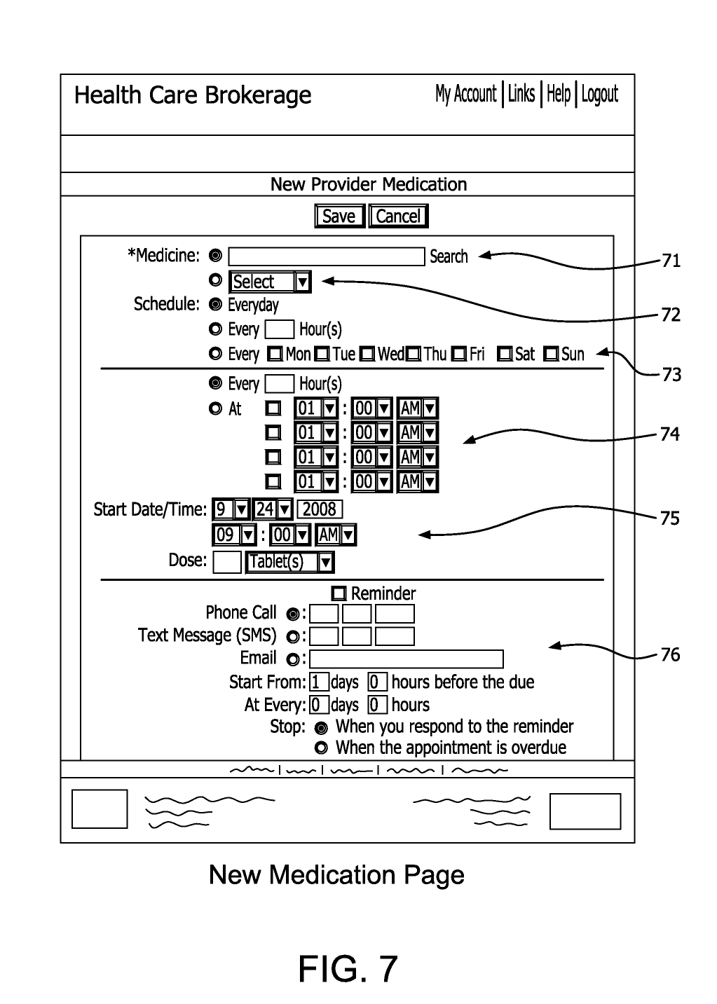

### IV.3.E Provider's New Medication Prescription Page (FIG. 7)

FIG. 7 is another example of New Event page. When a provider user logs-on the system, it shows next the At-A-Glance page (see FIG. 5). The system identifies the user through the log-in as a provider. When the user clicks on a Medication tab the system displays the page illustrated in FIG. 7.

The provider user can then enter the prescription 71, the patient 72 and times 73 and 74 for taking the medicine, how long 75. There is also an option for pharmacy and Reminders 76.

### IV.3.F Overviewing of History of Reminders and Events Calendar Page (FIG. 8)

A user can get an overview of history of events and reminders through a listing or graphically through widely used calendar page. The latter is illustrated in FIG. 8 A user can click on an entry in the calendar 77 to view respective event and reminder.

### IV.3.G. Event Pages for Other Event Types (FIG. 2)

FIG. 2, shows other New Event Pages 28 for Medication 28b, Exercise 28c, measurement Self-tests 28d, and Diet 28e. They are also contemplated and follow a similar scheme as the patient appointment page in FIG. 6. As should be understood, the above description of process of a patient requesting appointment is very similar to the process applied to the other types of events. It is applied as well to medication, self-testing, dieting and exercising. The event pages in FIG. 2, 28 are customized for use in respective event types. The At-A-Glance 26 and event pages 28 provide tabs for the various types of events included in the system. The processing of events may differ as follows.

An appointment event is a one-time event for the scheduled time. It includes reminders and recording of compliance with it. It may be initiated by provider offering the appointment to a patient or a patient requesting appointment from a provider.

The medication, self-test, dieting and exercise types of events have an initiation followed by periodic application, specified in the default page. Also compliance is recorded and evaluated. They can be initiated by either patient or provider and also by a patient self initiated.

The medication event is also communicated by the system to a pharmacy for filling and refilling. It is entered by the provider in initiating the medication event or in responding to a patient medication event.

The diet event page has free text description of the meal schedule and of the reminder schedule. In this case the provider may be a trainer or the patient himself or herself. The patient is then reminded at the default specified meal time in the At-A-Glance page and the user can indicate if complied with or not.

The exercise event page also has a free text description of the exercise schedule and respective exercise locations. The provider may be a trainer or the patient it. The system will generate reminders at the specified schedule and the patient can indicate if complied-with or not.

### IV.3.H. Other Pages (in FIG. 2)

Reward Page 42: Patients can get reward points by adhering to events supported by sponsors. Patients can check and redeem those points using the Rewards tab and page this would be similar to common existing pages for rewards.

Associate page 44: An Associates communication page is used so that a patient can create an associate to oversee own account. It allows monitoring the patient's events, schedules and their reminders. The patient sends to its associate login name and randomly generated password that the associate can modify. This process includes that the person accepts to be an associate. The associate is able to share the account owner's health care data. The associate is limited to events and reminders data.

Member Page 33: User Users of the system may consist of a family entitled to similar services as the user. This page facilitates registering such members.

Their insurance information may be edited

Account Page: 48: A user can modify, reset, or add all the personal information. Users can change their password, address, phone number, insurance information, default values for reminders, and the like. They also can add or modify dependents' members and their information here.

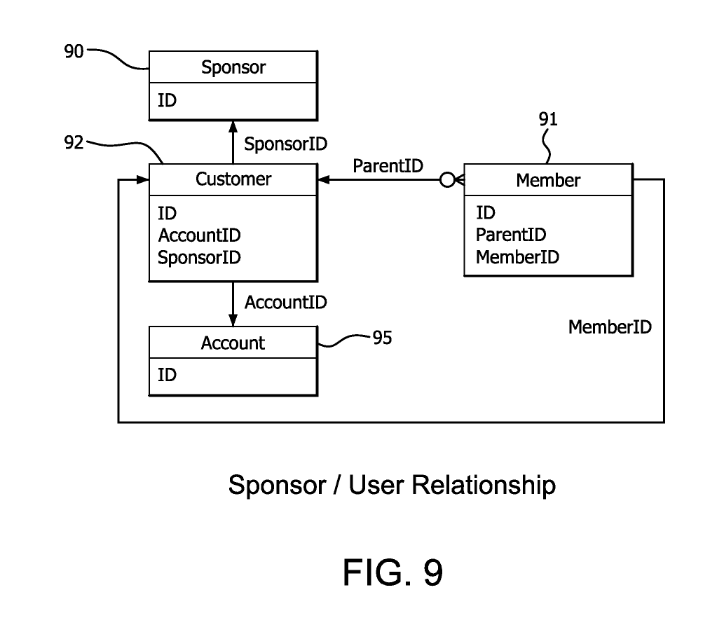

### IV.4. Data Structure Relationships (FIGS. 9 to 12)

As described above in connection with FIG. 1, the system 10 operation uses relational databases 10 and 43 that connect the various entities through their relationships. The system needs in its operation to obtain related data elements by using these relational connections. For example, when a user logs-in, it is necessary for the system to find if it is provider or patient, who is its sponsor, who are the members of the family, and the like. They are stored in different records that are interconnected and accessible through their relationships. FIGS. 9 through 12 illustrate the database structures of the various relational databases that support the operation of the system.

FIG. 9 is a schematic of the major entity relationship of the relational database. It shows the relation of a member (of user family) 91 through a member Id relation with a customer 92, through sponsor Id relation of a sponsor 90. The customer 92 has relationship through the Account Id with the respective account.

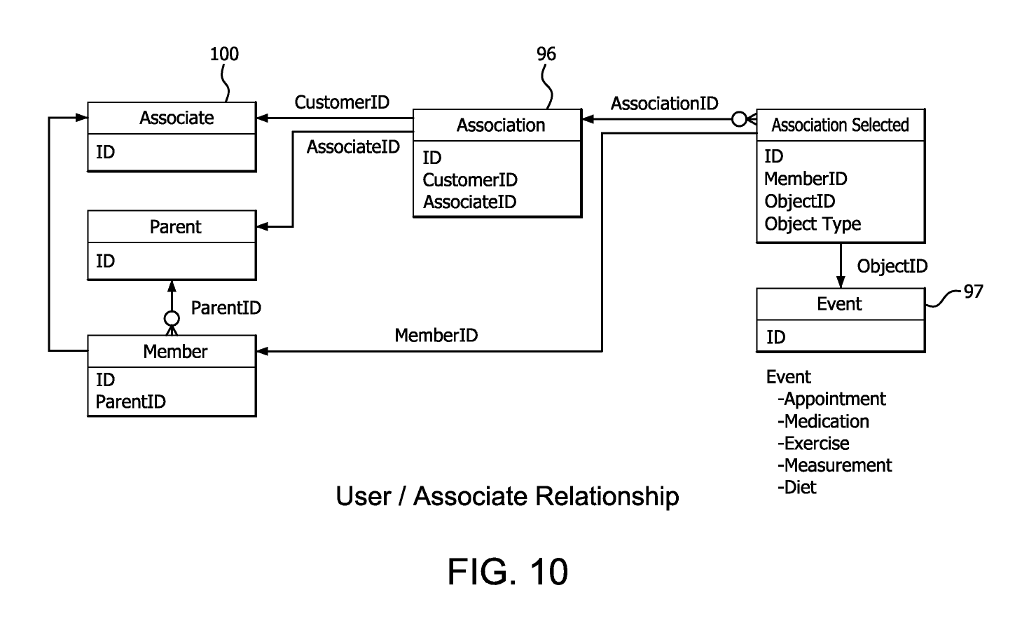

FIG. 10 is a schematic of the major entity relationship of the relational database for an association 96 relationships on one hand with the associate and on the other side with an event 97 accessed by the associate. The associate is enabled to view events of a user.

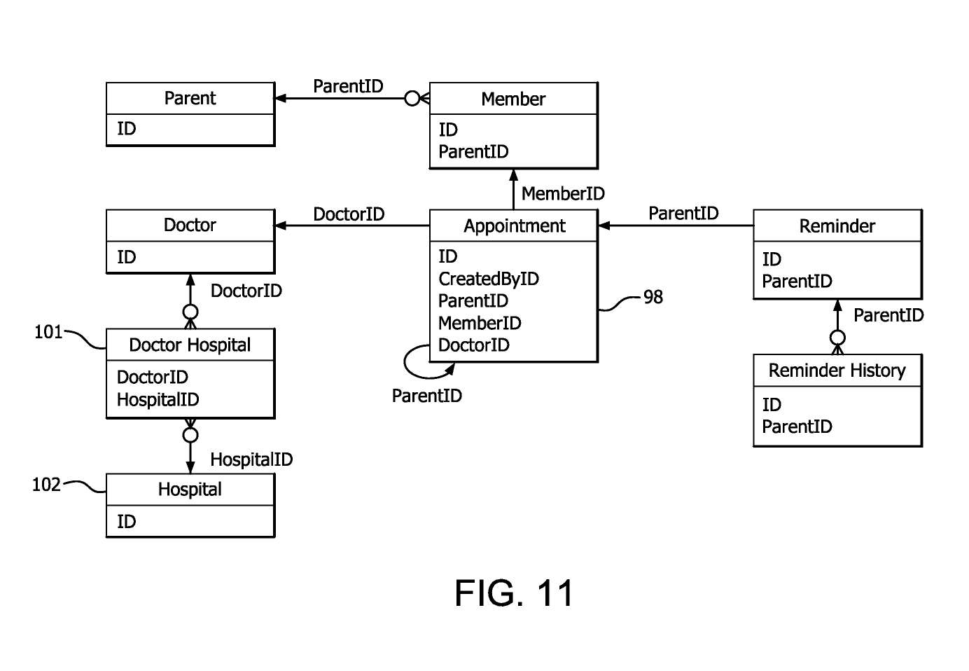

FIG. 11 is a schematic of the major entity relationship of the relational database for an appointment event 98 and its reminders. As shown it may involve Doctor 101, Hospital 102 and the like.

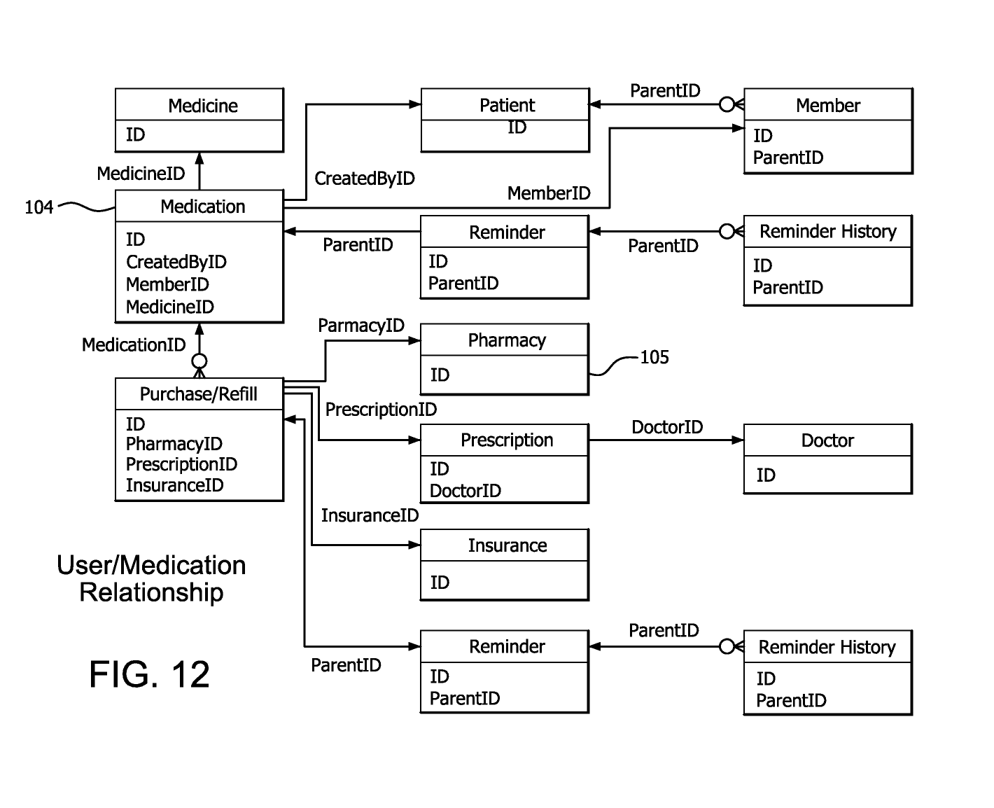

FIG. 12 is a schematic of the major entity relationship of the relational database for a medication 104 and its pharmacy 105.

V. Use of Web-Planner Tool for Generating IVR Programs with Speech Recognition to Emulate

a. Functionality of Website Pages of the Health Care Brokerage System

As described above in connection with FIG. 1, users of the Health Brokerage System 10 may communicate with other users 18 by Internet, text, or by phone. As shown, the service by Internet is implemented by website pages. The Interactive Voice Response (IVR) programs for each website page must emulate and be consistent with respective website pages. Also, the website pages are likely to be updated in time and the respective IVR programs must change with the website pages, as much as possible automatically. These programs should be consistent with the respective pages so that a user can switch at any time from one mode to the other. As stated above, the services by speech are required as they are easier to use and are required by patients that are elderly or sick and find it difficult to follow printed instructions and key in appropriate places in website pages. Manual development of the IVR programs would be very laborious due to the large number of pages for Patients, Providers, Associates and for Appointments, Medicine, Tests, Diet and Exercise. The use of a Web-Planner tool is described below to automate the creation of respective IVR programs. For these reasons it is a requisite in enabling the Health Care Brokerage, as well as similar systems.

Briefly, the Web-Planner tool process is as follows.

One input to the tool is the respective website page—the source code. A second input: is a call-flow, a very high level specification for an IVR. It specifies the prompts, calls, the respective database accesses and the use of speech directories and grammar to recognize speech of the user. The tool analyzes the page source program to find the location of calls for emulating the respective functions of the website page to be performed by the IVR program. The tool creates the respective IVR program. The IVR Program communicates with two executive programs that that execute the IVR program interactively with the user by speech.

A more detailed view of the automated development process of creating the IVR service is shown in FIG. 12.

As shown at the top of FIG. 12, in the first step a developer examines the functionality of the respective website page to be emulated 110. In a second step, the developer composes a high level representation in a form we call ‘Call Flow’ 112. It is based on the high level functionality of the website page. It consists of the following:

Prompts played to the caller. They may be generated from input text or from the website at run time.

Reads from the website page;

Writes to the website page;

Processes needed for the voice/speech environment (e.g., search a list)

Jumps with respective conditions to next steps; and

Speech vocabulary that needs to be recognized statically or dynamically (at run time);

This is the second input to the tool. It is entered step by step;

In the course of input of the call-flow steps, there is a need to locate interfacing information 114 between the IVR program and the website code that executes the step. This is done by the automatic search in the website client code. The Web-Planner tool assists in finding the interfacing. This information generated by the tool may include:

Where to read or write to the website code;

Apply grammar for speech recognition. This may be static defined once, dynamic defined at run time, or just-in-time created at run time; and

Content of processes to be executed.

The Web-Planner tool 116 accepts these inputs through a user interface. It assists in finding the appropriate in the website page codes by parsing to find the locations for reading and writing, and editing the predefined processes. The Web-Planner 116 reduces the development labor and time.

The output of the Web Planner is code 118, It is applied to two Executives 120 that execute the IVR program

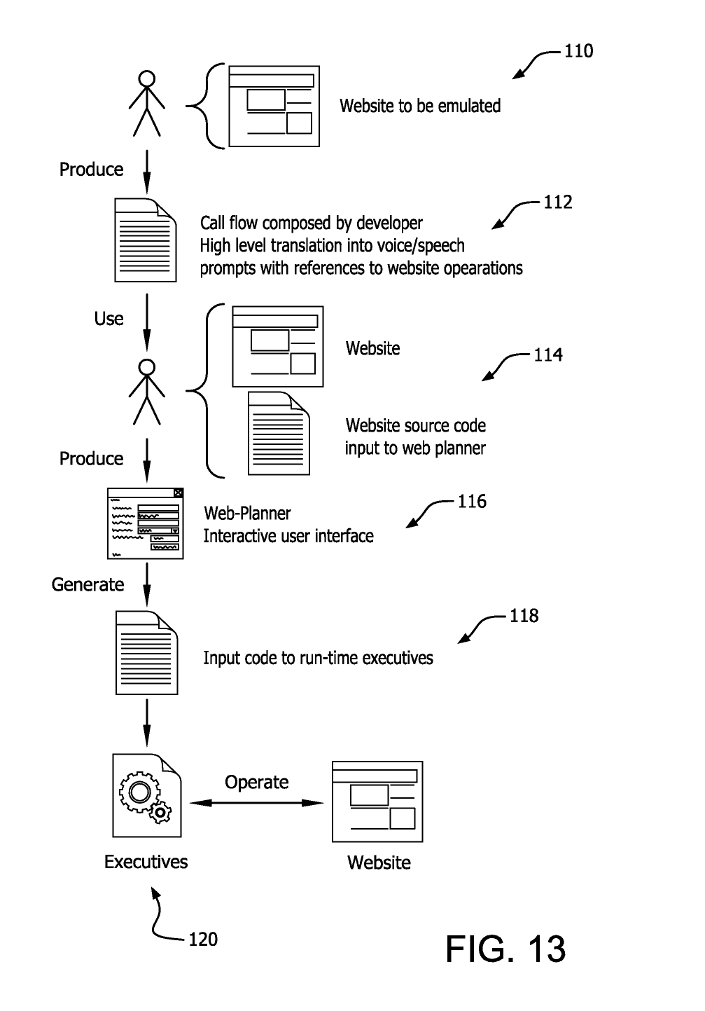

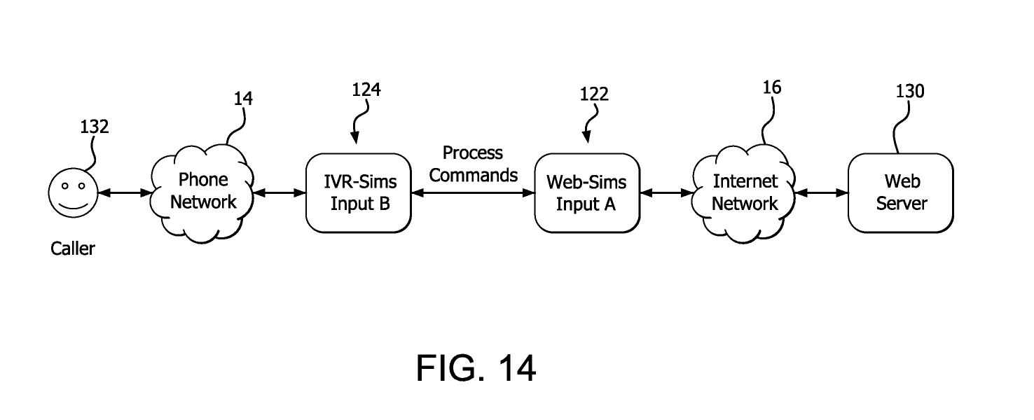

As shown in FIG. 14, there are two executives: Web-Sims 122, exchanges data with the website 130, and IVR-Sims 124 executes the call flow commands for communicating with the users, such as the users of the Health Care Brokerage system 130. These executives derive their information from the code created by the Web-Planner (FIG. 13, 118). They then operate the website 126 to obtain the respective services by speech via phone.

The output from the Web-Planner 118 is in two parts. One is denoted as INPUT A 124 that is input to the Web-Sims executive. The other is denoted INPUT B 122 that is the input to the IVR-Sims executive.

IVR-Sims obtains from Input B, FIG. 14, 122 essentially an elaboration of the call-flow. It may be viewed as a network of nodes with transitions between them. IVR-Sims executes the nodes and traces transitions for jump conditions from node to node. Each node consists of groups of statements that may need to be executed in parallel (such as prompt and capture response). These groups are executed sequentially in the order given in each node.

Web-Sims 122 executes processes which involve exchange of information with the emulated website. In this way it uses the facilities of the website whenever it is needed and useful. Web-Sims obtains the parameters of these processes from Input A. However, Web-Sims gets also commands to execute the process from IVR-Sims 124 when it executes process statements. Web-Sims has built in capabilities to get and post data in the website and search the website. The parameters are provided in Input A 124.

There are IVR programs for each website page. The IVR program for the Home page (see FIG. 2) starts in response to an incoming call and activates the IVR-sim and Web-Sims. While the call continues, the IVR programs switch same as the respective website pages IVR-Sims and Web-Sims cooperate with each other. The main role of IVR-Sims is interacting with the caller. The main role of Web-Sims is web-simulation by request-response originating from IVR-Sims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A health care brokerage service comprising:
a communication service for servicing users, patients and providers through the internet and/or via phone by speech, through user guides;
a brokering service that users, patients and providers can utilize for finding each other and broker services of health-care events; and
a compliance service for enhancing compliance by patients with health-care events, through persistent reminders and through retaining and evaluating compliance history;
wherein the system implementation incorporate users interfaces, storage of related data, and the execution of requested services.

2. The health care brokerage service according to claim 1 wherein the brokering service further comprises:
automatically mediating the scheduling of an event and reaching an agreement between an initiating party and a destination party;
proactively and persistently communicating between the initiator party and the destination party for agreeing on the scheduling of the event based on the event specified by the initiator party;
searching directories to locate membership, email or telephone addresses for the selected destination parties;
communicating proactively, through Internet and/or telephone calls, as necessary, with the destination party with a request to agree on a schedule of the event, the service reports to the initiator party the progress in contacting the destination party;
if contacted, the brokering service reports to the initiator party the response of the destination party on agreement on the schedule, if agreement is reached, the brokering service updates the event for both the initiating and destination parties and establishes due reminders; and
if no contact is made with the destination party, after repeated trials, or if there is no agreement on the event, the brokering service solicits from the initiator other schedule or other destination parties and repeats the above process to schedule the initiator requested event.

3. The health care brokerage service according to claim 1 further comprising:
creating interactive Voice Response (IVR) programs, semi-automatically, that emulate respective website pages, for users to employ natural language in communicating with the system same as with respective website pages that offer the same respective service;
a tool which uses as inputs the source website page code and a high level call flow of the emulation of the website page service by speech, the call flow includes commands to generate natural language prompts, to access, store, and update storage via the website code; and
for using natural language grammar systems and directories to understand the user's utterance.

4. The health care brokerage service according to claim 1 wherein the compliance service further comprises:
managing the compliance with health care events analyzing the healthcare event compliance history and creating an index of compliance of patients with the health care events, and finding non-compliant patients that need special services to improve their compliance and to reduce health care costs.

5. The health care brokerage service according to claim 1, further comprising a service for having a trusted associate dub free speech in his/her own voice in system prompts to users, thereby increasing the familiarity and friendliness of the communication to non-complaint patients to improve compliance and reducing cost

6. A health care brokerage method comprising the steps of:
providing a communication service for servicing users, patients and providers through the internet and/or via phone by speech, through user guides;
providing a brokering service that users, patients, and providers utilize for finding each other and broker services of health-care events; and
providing a compliance service for enhancing compliance by patients with health-care events, through persistent reminders and through retaining and evaluating compliance history, wherein the system implementation incorporate users interfaces, storage of related data, and the execution of requested services.

7. The health care brokerage method according to claim 1 wherein the brokering service further comprises:
automatically mediating the scheduling of an event and reaching an agreement between an initiating party and a destination party;
proactively and persistently communicating between the initiator party and the destination party for agreeing on the scheduling of the event based on the event specified by the initiator party;
searching directories to locate membership, email or telephone addresses for the selected destination parties;
communicating proactively, through Internet and/or telephone calls, as necessary, with the destination party with a request to agree on a schedule of the event, the service reports to the initiator party the progress in contacting the destination party;
if destination party is contacted, the brokering service reports to the initiator party the response of the destination party on agreement on the schedule;
if agreement is reached, the brokering service updates the event for both the initiating and destination parties and establishes due reminders; and
if no contact is made with the destination party, after repeated trials, or if there is no agreement on the event, the brokering service solicits from the initiator other schedule or other destination parties and repeats the above process to schedule the initiator requested event.

8. The health care brokerage method according to claim 1 further comprising:
creating Interactive Voice Response (IVR) programs, semi-automatically, that emulate respective website pages, for users to employ natural language in communicating with the system same as with respective website pages that offer the same respective service;
a tool which uses the following inputs:
the source website page code, and
a high level call flow of the emulation of the website page service by speech;
the call flow includes commands to generate natural language prompts, access, store, and update storage via the website code and for using natural language grammar systems and directories to understand the user's utterance.

9. The health care brokerage method according to claim 1 wherein the compliance service further comprises:
managing the compliance of health care events and analyzing the healthcare event compliance history and creating an index of compliance of patients with the health care events, and finding non-compliant patients that need special services to improve their compliance and to reduce health care costs.

10. The health care brokerage method according to claim 1, further comprising a service for having a trusted associate dub free speech in his/her own voice in system prompts to users, thereby increasing the familiarity and friendliness of the communication to non-complaint patients to improve compliance and reducing costs.

11. The health care brokerage service comprising:
automatically mediating a scheduling of an event and reaching an agreement between an initiating party and a destination party;
proactively and persistently communicating between the initiator party and the destination party for agreeing on the scheduling of the event based on the event specified by the initiator party;
searching directories to locate membership, email or telephone addresses for the selected destination parties;
communicating proactively, through Internet and/or telephone calls, as necessary, with the destination party with a request to agree on a schedule of the event, the service reports to the initiator party the progress in contacting the destination party;
if the destination party is contacted, the brokering service reports to the initiator party the response of the destination party on agreement on the schedule, if agreement is reached, the brokering service updates the event for both the initiating and destination parties and establishes due reminders; and
if no contact is made with the destination party, after repeated trials, or if there is no agreement on the event, the brokering service solicits from the initiator other schedule or other destination parties and repeats the above process to schedule the initiator requested event.

12. The health care brokerage service comprising:
creating Interactive Voice Response (IVR) programs, semi-automatically, that emulate respective website pages, for users to employ natural language in communicating with the system same as with respective website pages that offer the same respective service;
a tool which uses as inputs the source website page code and a high level call flow of the emulation of the website page service by speech;
the call flow includes commands to generate natural language prompts to access, store, and update storage via the website code; and
for using natural language grammar systems and directories to understand the user's utterance.
